(19) United States
(12) Patent Application Publication
(10) Pub. No.: US 2024/0425390 A1
(43) Pub. Date: Dec. 26, 2024

(54) DIAMOND ELECTRODE

(71) Applicants: Element Six Technologies Limited, Oxfordshire (GB); University of Warwick, Coventry (GB)

(72) Inventors: Joshua James TULLY, Coventry (GB); Georgia WOOD, Coventry (GB); Irina Michelle TERRERO RODRÍGUEZ, Coventry (GB); Julie Victoria MACPHERSON, Coventry (GB); Mark Edward NEWTON, Coventry (GB); Timothy Peter MOLLART, Oxfordshire (GB); Hossein ZARRIN, Santa Clara, CA (US)

(21) Appl. No.: 18/686,121

(22) PCT Filed: Jul. 5, 2022
(86) PCT No.: PCT/EP2022/068654

§ 371 Date: Feb. 23, 2024

(30) Foreign Application Priority Data
Aug. 26, 2021 (GB) 2112229.6

(51) Int. Cl. C02F 1/461; B23K 26/36; C02F 1/467; C25F 3/02

(52) U.S. Cl. CPC C02F 1/46109; B23K 26/36; C02F 1/4672; C25F 3/02; C02F 2001/46147; C02F 2001/46157

(57) ABSTRACT

An electrode and a method of forming an electrode, the electrode being formed from boron doped diamond, the electrode having a total solution accessible electrode area comprising at least 60% diamond stabilised non-diamond carbon. There is also disclosed an electrochemical cell the electrode.

### FIELD

The invention relates to the field of diamond electrodes, in particular diamond electrodes formed from boron-doped diamond, and to electrochemical cells containing such electrodes. Furthermore, the invention relates to the field of methods of forming such electrodes, and methods of using such electrochemical cells.

### BACKGROUND

Ozone is a highly oxidising molecule capable of existing in the gas or dissolved phase, with applications including sterilisation and sanitisation, deodorisation, and decolourisation. One of the chief advantages of ozone over other oxidisers is the absence of harmful residues. Most commonly ozone is employed in the dissolved form in the water treatment industries where it is used to remove contaminants in the treatment of waste and drinking water. However, due to the limited half-life of ca. 20 minutes, ozone must be generated in-situ.

Electrochemical ozone production (EOP) has gained in popularity due to its simplicity, as ozone can be produced directly from water by electrochemical oxidation. The generally accepted mechanism for EOP⁷ involves generating surface bound hydroxyl radicals, which decay to produce adsorbed oxygen radicals. The oxygen radicals can either react together to form adsorbed oxygen molecules or react with water molecules to form an adsorbed OOH radical; the latter leading eventually to oxygen evolution. Once adsorbed oxygen is produced, it can react with a further adsorbed oxygen radical to form ozone or simply desorb from the surface as oxygen. The eventual pathway water oxidation takes will depend on the binding energies of radical species and oxygen molecules on the electrode surface of interest. Electrodes with a high overpotential for the oxygen evolution reaction (OER) are likely to give higher current efficiencies as ozone generation will be a preferred pathway for water oxidation.

Historically, Pt and PbO₂ were early electrode materials used for ozone production, employed under sub-ambient temperatures to increase ozone solubility, although others such as SnO₂ have also found use (see Foller et. al., The electrochemical generation of high concentration ozone for small-scale applications, Ozone Sci. Eng., 1984, 6, 29-36). Whilst commercial EOP systems exist which employ PbO₂ anodes they suffer from electrode erosion and Pb contamination issues, as is typical with other metal based EOP systems. It is for this reason boron doped diamond (BDD) electrodes, which are well known for demonstrating increased durability, present no contamination concerns, and have a high overpotential towards OER, are one of the most popular choices for commercial EOP devices (see Arihara et. al., Electrochemical Production of High-Concentration Ozone-Water Using Freestanding Perforated Diamond Electrodes, J. Electrochem. Soc., 2007, 154, E71, and Arihara et. al., Electrochem. Solid-State Lett., 9, D17 2006).

In commercial applications it is desirable to generate ozone from electrolyte-free solutions (pure water) to avoid reducing the current efficiency of the ozone generation process due to competing side reactions involving electrolysis of the electrolyte counter ions, as well as to present a route to reagent-free ozone generation.^{13,14} However, due to the low conductivity of the solution is it necessary to use a solid electrolyte e.g. a proton transporting Nafion™ membrane which is sandwiched between two BDD electrodes (zero gap cell). The electrodes are almost always used in a porous form and include placing thru-holes into thick freestanding BDD or growing thin film BDD on holey substrates (see Kraft et. al., Electrochemical ozone production using diamond anodes and a solid polymer electrolyte, Electrochem. commun., 2006, 8, 883-886). Hole creation is important in allowing solution access to the Nafion™. This results in a Nafion™-solution-BDD “triple-point” which some believe is also where ozone is generated. Whilst the cost of producing thin film BDD is less than the freestanding material, it can be challenging to grow pin-hole free BDD on a geometrically challenging substrate; even at moderate current densities, pin-holes will result in delamination of the BDD film and premature electrode failure. Using zero gap cells, BDD electrodes compete favourably with PbO₂ anodes in terms of current efficiency, although they do require higher operating voltages.

The surface of the BDD electrode has been debated in the EOP literature. Whilst some researchers comment on the preferred use of a non-diamond carbon free surface i.e. pristine BDD, there has been limited experimental work which suggests that sp² bonded carbon impurities present in the BDD can increase ozone output (see Watanabe et. al., Tailored design of boron-doped diamond electrodes for various electrochemical applications with boron-doping level and sp² bonded carbon impurities, Phys. Status Solidi Appl. Mater. Sci., 2014, 211, 2709-2717; and Honda et. al., An electrolyte-free system for ozone generation using heavily boron-doped diamond electrodes, Diam. Relat. Mater., 2013, 40, 7-11). This work emphasises the importance of keeping the fraction of sp2 bonded carbon impurities low in order to retain the durability of the electrode and maintain structural stability of the BDD film. In particular it was stated “the amounts of sp²-bonded carbon impurities in the films were controlled to be low enough to retain the durability of diamond. . . . Although the Raman spectra indicate that BDD-B and D contain some non-diamond sp²-bonded carbon impurities, the fraction of sp²-bonded carbon is very low” and “it is important to note that the presence of the sp² structure decreased the stability of the BDD.” In their studies, the sp² bonded carbon was introduced during chemical vapour deposition (CVD) growth by varying the boron to carbon feedstock ratio from 0.1% to 5%. As these sp² bonded carbon impurities are grown-in, they will be present throughout the film, not just at the surface. Note in these studies both boron concentration and sp² bonded carbon content were changed at the same time, and the impact of a changing material conductivity (from varying the boron concentration) was not accounted for in the results obtained.

### SUMMARY

This invention describes the optimisation of BDD electrodes for disinfection species production due to the creation of high levels of sp² bonded surface carbon. In contrast to the current literature, the present invention proposes providing BDD electrodes having at least 60% of the surface covered in sp² bonded carbon, which is a level well beyond what is currently taught to be an optimal coverage for BDD EOP operation. The high sp² bonded carbon surface content BDD electrode results in an increased output towards EOP, which we attribute to an increased density of possible radical/oxygen binding sites on the BDD surface. Surprisingly, such electrodes, even though they contain such a high sp² bonded carbon content, are also able to maintain structural stability and thus ozone output stability under the very high current density (voltage) operating conditions of EOP for long periods of time e.g. at least 20 hours. We refer to the sp2 bonded carbon regions created using our method as diamond stabilised non-diamond carbon (DSC), given it can withstand the extreme operating conditions of EOP.

A preferred method for introducing such high surface coverages of DSC is via a combination of ablative machining and post ablation chemical treatment to produce DSC. In this method, thermal damage of the BDD by the high energy discharge of, for example, a laser beam results in conversion of diamond to graphite. Subsequent chemical treatment results in DSC. The DSC resides as a layer (which may typically be up to 10's of nm) of substantially vertically aligned graphite sheets of carbon, at the point of intimate contact to the underlying BDD, at least partly encapsulated by an amorphous carbon shell, which may be less than 10 nm thick (see Cobb et. al., Assessment of acid and thermal oxidation treatments for removing sp² bonded carbon from the surface of boron doped diamond, Carbon N. Y., 2020, 167, 1-10).

According to a first aspect, there is provided an electrode formed from boron doped diamond, the electrode having a total solution accessible electrode area comprising at least 60% diamond stabilised non-diamond carbon.

This type of solution accessible electrode area can be applied to different types of boron doped diamond materials, including free standing CVD BDD, thin film coatings of CVD BDD on a conductive substrates (with preferable thicknesses in a range of 0.5 to 50.0 μm) and BDD materials produced via high temperature and pressure (HPHT) synthesis of BDD particles that are then sintered or compacted into a polycrystalline matrix material.

As an option, the total solution accessible electrode area comprises any of at least 70%, 80%, 90%, and 95% diamond stabilised non-diamond carbon.

As an option, the diamond stabilised non-diamond carbon comprises oriented graphite bonded to the diamond surface with a layer of amorphous carbon, wherein the graphite is oriented at the point of bonding to the diamond surface at greater than 20° relative to the plane of the total solution accessible electrode area.

As an option, the boron doped diamond is selected from any of CVD diamond, HPHT diamond and compacted HPHT diamond.

The boron doped diamond is optionally in the form of a coated layer on a conductive or non-conductive backing.

As an option, the diamond stabilised non-diamond carbon is formed at the solution accessible electrode area by an ablative machining technique and subsequently applying an oxidising treatment to the solution accessible electrode area. As a further option, the oxidising treatment comprises treating for at least 10 minutes in a liquid comprising any of sulphuric acid and potassium nitrate; sulphuric acid and hydrogen peroxide; nitric acid and hydrochloric acid; hydrofluoric acid; hypochlorous acid; nitric acid, perchloric acid and sulphuric acid; and permanganates selected from any of potassium permanganate, ammonium permanganate, calcium permanganate, sodium permanganate, and silver permanganate.

The oxidising treatment optionally comprises electrochemical oxidation.

The solution accessible electrode area optionally further comprises any of slots, depressions and non-planar surface features.

As an option, bulk boron doped diamond away from the solution accessible electrode area comprises significantly less sp² bonded carbon than the solution accessible surface. The quantity of sp² bonded carbon in the bulk material may be at least five times less than the quantity at the solution accessible surface area.

According to a second aspect, there is provided an electrochemical cell comprising a first electrode as described above in the first aspect, a second opposing electrode, a flow path configured for flowing a fluid, drive circuitry configured to apply a potential across the electrodes such that a current flows between the electrodes when the fluid is flowed through the flow path, and a sealed housing in which the electrodes are disposed, the housing configured to contain the fluid within the flow path.

As an option, the electrochemical cell is configured for ozone generation when in use.

As an option, during use and over a voltage range of 5 to 10 V and a current density range of 0.01 up to 0.05 A cm⁻² with de-ionized (greater than 15 MΩ cm) water at a nominal temperature of 25° C. and a flow rate of 240 ml⁻¹, the peak ozone current efficiency is greater than 25%. As a further option, the peak ozone current efficiency is selected from any of at least 30% and at least 35%.

As an option, an ozone output gradient decreases by no more than 10% over a time of at least 5 hours of continuous running. As a further option, the 5 hour time period is measured after an initial use period of at least 20 hours.

As an option, during use, an ozone productivity gradient is a least squares linear regression fit with a coefficient of determination, denoted R²>0.95 over the current density range 0.01 to 0.05 A cm⁻² with an applied voltage of 5 to 15 V operating in water with a resistivity greater than 15 MΩ cm with a flow rate of 240 ml min⁻¹.

According to a third aspect, there is provided a method of forming an electrode, the method comprising providing boron doped diamond and applying a surface modification process to form a total solution accessible electrode area comprising at least 60% diamond stabilised non-diamond carbon.

Optionally, the surface modification process comprises an ablative machining process.

As an option, the ablative machining process comprises laser ablation. In this instance, the laser ablation is optionally performed using a laser of wavelength from 355 to 1064 nm, a pulse length between 10 and 500 ns, a pulse frequency in a range of 50 Hz to 25 MHz, and a fluence of >10 J cm⁻² at a passing speed of 0.1 to 100,000 mm s⁻¹.

As an alternative option, the ablative machining process comprises electrical discharge machining. In this instance, the electrical discharge machining is optionally performed with an electrode gap of between 0.05 and 3.00 mm, an applied voltage of between 5 and 60 V and a current of between 0.1 and 5.0 A with a pulse time of between 10 and 300 μs.

The ablative machining process is optionally further used to form any of slots, depressions and non-planar surface features at the solution accessible electrode area.

The method optionally further comprises applying an oxidising process step to the total solution accessible electrode area, the oxidising process comprising applying an oxidising environment to the solution accessible electrode area. The oxidising process optionally comprises treating for at least 10 minutes in a liquid comprising any of sulphuric acid and potassium nitrate; sulphuric acid and hydrogen peroxide; nitric acid and hydrochloric acid; hydrofluoric acid; hypochlorous acid; nitric acid, perchloric acid and sulphuric acid; and permanganates selected from any of potassium permanganate, ammonium permanganate, calcium permanganate, sodium permanganate, and silver permanganate. Alternatively, the oxidising process optionally comprises electrochemical oxidation.

The method optionally comprises applying to the solution accessible electrode area any of an electrochemical anodic process, an oxygen plasma processing, and a chemical/electrochemical reduction process.

Optionally, the method comprises providing a first electrode as described above in the first aspect, providing a second opposing electrode, providing a flow path configured for flowing a fluid, providing drive circuitry configured to apply a potential across the electrodes such that a current flows between the electrodes when the fluid is flowed through the flow path, and providing a sealed housing in which the electrodes are disposed, the housing configured to contain the fluid within the flow path.

The method optionally comprises disposing a solid electrolyte between the first and second electrodes. As a further option, the method comprises treating the solid electrolyte prior to use by hydrating and protonating the solid electrolyte.

According to a fourth aspect, there is provide a method of using an electrochemical cell, the method comprising providing an electrochemical cell as described above in the second aspect, causing a fluid to flow in the flow path, and applying a potential across the electrodes such that a current flows between the electrodes.

The method optionally further comprises applying the potential across the electrodes via a dry electrical contact such that the only electrochemically active electrode material is the boron doped diamond electrode.

### BRIEF DESCRIPTION OF DRAWINGS

Non-limiting embodiments will now be described by way of example and with reference to the accompanying drawings in which:

FIG. 1 illustrates schematically an exemplary electrochemical EOP cell;

FIG. 2 shows exemplary ways of calculating the total solution accessible electrode area;

FIG. 3a shows ozone output gradient of an electrochemical EOP cell versus an accessible DSC fraction expressed as a (%) solution accessible area of a BDD electrode;

FIG. 3b shows peak current efficiency of an electrochemical cell versus an accessible DSC fraction (%) of a BDD electrode surface;

FIG. 4 shows an optical image of a corroded glassy carbon electrode after use in an EOP electrochemical cell;

FIG. 5 shows ozone output gradient versus electrode thickness for a perforated electrode design;

FIG. 6a shows UV absorbance at 258 nm versus time for an exemplary BDD electrode cell;

FIG. 6b shows dissolved ozone concentration versus current for an exemplary BDD electrode cell;

FIG. 6c shows current efficiency versus applied current for an exemplary BDD electrode cell;

FIG. 7a is a photograph of an electrode formed from compacted HPHT microparticles cut into a desired geometry and adhered into a half cell;

FIG. 7b shows dissolved ozone concentration versus current;

FIG. 7c shows current efficiency versus applied current;

FIGS. 8a and 8b show UV absorbance at 258 nm versus time for a CVD BDD electrode cell and an HPHT BDD electrode cell respectively;

FIG. 8c shows dissolved ozone concentration versus current after long term stability testing for a CVD and HPHT electrode cell;

FIG. 9 is a flow diagram showing exemplary steps for forming a BDD diamond electrode;

FIG. 10 is a flow diagram showing exemplary steps for forming a BDD diamond electrochemical cell; and

FIG. 11 is a flow diagram showing exemplary steps for using a BDD diamond electrochemical cell.

### DETAILED DESCRIPTION

As described above, to date there has been an emphasis on keeping the fraction of sp² bonded carbon impurities low in BDD for EOP. The inventors have found introducing DSC in large quantities at the surface not only improves the properties of the BDD electrode towards EOP but also, surprisingly, the electrode is able to maintain output stability over long periods of time during EOP (at least 20 hours).

The DCS need only be present at the solution accessible electrode area of the electrode; it is not necessary to have sp² bonded carbon disposed throughout the thickness of the electrode. It has been found that DSC can be introduced using a combination of ablative machining and post ablation chemical treatment. It is proposed that the ablative machining forms sp² bonded carbon such as graphite by introducing thermal damage to the BDD surface, and subsequent treatments can stabilise the sp² bonded carbon to form DSC. These subsequent treatments can be performed before the BDD electrode is placed in an electrochemical cell, or in-situ in an electrochemical cell as part of a conditioning process. As described above, the DSC resides as a layer (which may typically be up to 10's of nm) of vertically aligned graphite sheets of carbon, at the point of intimate contact to the underlying BDD, encapsulated by an amorphous carbon shell (which may be less than 10 nm thick).

Examples of producing BDD diamond electrodes with a stable layer of DSC for EOP are provided below:

### Cell Design

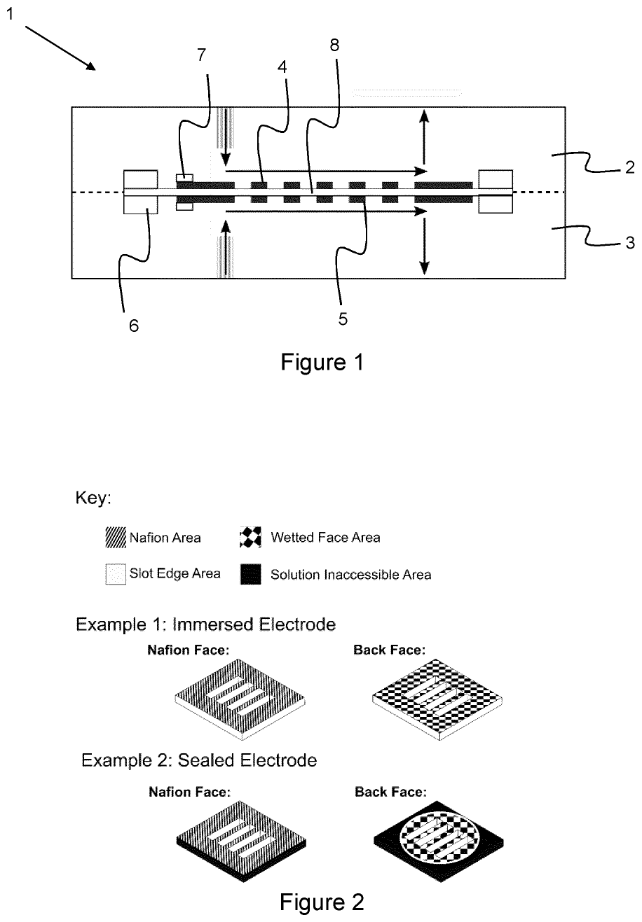

FIG. 1 illustrates schematically an electrochemical cell design. Each cell 1 comprises two separate half cells 2, 3. The half-cells 2, 3 were 3D printed using a Form 3 (FormLabs) and UV curing clear polymethylmethacrylate (PMMA) resin (FormLabs Standard Clear, FormLabs) with a 50 μm layer height. They were then washed for 10 minutes in isopropyl alcohol (Reagent Grade, Fisher Scientific), followed by a 20 minute UV cure at 60° C. This process is to ensure excess resin is removed and to achieve optimal material properties of the resin parts. The support material was then removed, and the faces polished using increasing grades of CarbiMet papers (Buhler, USA) until flat.

The perforated electrode cell was comprised of two identical halves each containing a perforated BDD electrode 4, 5, a recess to accommodate the BDD electrodes, 3D printed gaskets 6, slots for copper tab contacts 7 and a channel for solution flow across the backside of the electrode as shown in FIG. 1.

Electrodes 4, 5 were adhered to the recess in each half-cell 2, 3 using UV resin (FormLabs Clear, FormLabs). Silver loaded epoxy (Conductive Epoxy, CircuitWorks, Chemtronics) was used to make electrical contact to the electrode contact. The resulting half-cells are identical and are labelled A and B. Each half cell 2, 3 can serve as either the anode or cathode. Before cell testing, BDD electrodes 4, 5 were polished with alumina microparticles (0.05 μm, Buehler, Germany) on a wetted microcloth pad (Buehler), and then on a wetted alumina-free microcloth pad. For a tight seal, elastomeric 3D printed gaskets (FormLabs Elastic 50A, FormLabs, USA) were placed into the recess on each half-cell 4, 5 to seal around a Nafion™ membrane 8. A 2 cm diameter round of reinforced Nafion™ perfluorinated membrane (Nafion™ 424 reinforced with poly(tetrafluoro-ethylene) fiber, 0.33 mm, Sigma-Aldrich) was placed between the half-cells 3, 4, which are then bolted together.

### Forming Perforated BDD Electrodes With DSC

The perforated BDD electrodes 3, 4 were machined from a freestanding polycrystalline BDD wafer (420 μm unless otherwise specified, boron dopant density>10 B atoms cm⁻³, Element Six) using a 355 nm Nd: YAG 34 ns laser micromachining system (E-355H-ATHI-0 system, Oxford Lasers). The growth-face of the as-grown wafer had a roughness of ˜15 μm RMS, while the nucleation face roughness was ˜100 nm RMS, both measured using white-light interferometry (WLI).

A trepan system was used to widen the laser spot diameter to 50 μm in order to make the cut trench wider. This ensured the cut edges were perpendicular to the BDD and prevented the beam from interfering with the trench sides, removing the need for kerf on cuts. Electrodes 3, 4 were cut using two passes with a fluence of 760 J cm⁻¹ per pass. BDD was cut into rounds of different diameters (12 or 24 mm) with a 3×2 mm tab for ease of electrical contacting. Through-holes of different geometries were cut from the central region. The nucleation face of the contact tab was laser-roughened using a 532 Nd: YAG 15 ns laser micromachining system (A-Series, Oxford Lasers) with a fluence of ˜30 J cm⁻¹ in order to improve the adhesion of the Ti/Au contact when applied.

### Perforated HPHT Compact Electrode Creation

Freestanding HPHT BDD electrodes were produced using a binder-free HPHT compaction process (at 6.6 GPa and 1700° C. in a cubic anvil press) of HPHT synthesised BDD microparticles. The microparticles were grown from a Fe/Ni/C melt with 4.8 wt % AlB₂ as the boron source (as described in detail in Wood et. al., High pressure high temperature synthesis of highly boron doped diamond microparticles and porous electrodes for electrochemical applications, Carbon N. Y., 2021, 171, 845-856). This method produces freestanding cylindrical compacted electrodes, herein referred to as “compacts” with a diameter of approximately 16 mm, a thickness of 2 mm, a boron content of ca. 2-3×10²⁰ B atoms cm⁻³, and a resistivity of ca. 650 mΩ.

The 2 mm thick compacts were sliced using electrical discharge machining (EDM) to give ˜500 μm thick electrodes. The electrodes were cut into 8 mm diameter rounds with a rectangular tab (3×2 mm) for ease of electrical contacting, via the rear of the electrode in a substantively dry electrical contact, and through holes cut, using the same laser conditions as for the CVD electrodes above.

### Electrode Treatments to Form DSC

After lasering, all electrodes were immersed in concentrated H₂SO₄ saturated with KNO₃ for 30 minutes at ˜200° C., a strongly oxidising solution, followed by rinsing with ultrapure water before placement in a concentrated H₂SO₄ solution at ˜200° C. for another 30 minutes. This process removes any weakly-attached sp² bonded carbon introduced during laser machining and leaves behind the very robust form of sp² bonded carbon, DSC (see Cobb et. al., referred to above). Strongly oxidising conditions can be created by several methods including concentrated H₂SO₄ and H₂O₂, aqua regia [HNO₃ and HCl], HF and HNO₃, other oxidising agents such as potassium permanganate and thermal processes such as plasma etching or other conditions that etch graphite in controlled conditions.

Electrical contacts were added by sputtering a thin layer of Ti (10 nm) followed by a second layer of Au (400 nm) (Moorfield MiniLab 060 Platform Sputter system) onto the laser-roughened contact tabs of the perforated electrodes and the back, lapped face of the planar electrodes. The contact was annealed at 400° C. for 5 hours in order to create an ohmic connection.

### Ozone Measurements

Ultrapure water (Milli-Q, resistivity>15 MΩ cm⁻¹) was flowed from a reservoir through the ozone cells with flow rates of ˜330 mL min⁻¹ using a diaphragm pump. Galvanostatically currents ranging from 0.1 to 0.6 A in 0.1 A increments were applied using a Voltcraft VLP-2602 OVP power supply (Voltcraft). Ozonated water aliquots were collected after 30 s. Ozone concentrations were determined by recording the absorbance at 258 nm in a Lambda 850 UV/Vis spectrometer (Perkin Elmer) using a quartz cuvette (Hellma Analytics) with a 1 cm optical path and a molar absorption coefficient of 2900 M⁻¹ cm⁻¹.

To hydrate and protonate the Nafion™ membrane prior to use, one side of the cell was run at 0.6 (12 mm electrodes) or 0.3 A (for 8 mm electrodes) for 5 minutes. The pre-treatment was applied with the A side BDD electrode connected as the anode, before immediately recording the triplicate calibration with side A as the anode (and thus side B is the cathode). Then, the pre-treatment was applied again with the B side BDD electrode connected as the anode, before immediately recording the triplicate calibration with side B as the anode. The conditions selected gave a stable response between repeated calibrations, producing consistent current/voltage and current/ozone output data.

### Long-Term Testing

For long term cell stability testing, the UV absorbance at 258 nm was recorded as a function of time over a 20 h continuous operation time period at a constant current of ˜0.3 A for the 12 mm cells and ˜0.15 A for the 8 mm cells. Calibrations were performed in triplicate with electrode A and then B operated as the anode for ozone production before and after long term testing. A 10 L Dl water reservoir was recirculated through the ozone cell using a diaphragm pump. Water from the reservoir flowed through the ozone cell, exiting to a flow through cuvette (45FL; FireflySci) in the UV-vis system, through a system to remove ozone, and then back into the 10 L reservoir. The system to remove ozone was a high surface area quartz tube system between two 254 nm UV lamps (at 254 nm dissolved ozone is converted to oxygen⁴).

### RESULTS AND DISCUSSIONS

### Measurement Metrics

Total area and DSC content: FIG. 2 shows examples of the calculated total area for both immersed (wherein the electrode is suspended in the electrolyte and accessible to solution on all but the Nafion™ face) and sealed (wherein the electrode is adhered or sealed into a cell leaving only part of one face accessible to solution) electrodes. The checked region represents the wetted back face area, the white region represents the internal slot areas, the striped region represents the face excluded from solution by the Nafion™ membrane. The black region represents other areas which are inaccessible to solution.

For the perforated electrodes, the face of the BDD that is pressed in contact with the Nafion™ membrane is considered to be solution excluded. The total solution accessible electrode area is therefore the wetted back face area plus the internal ablated areas of the flow-through slots machined into the BDD (referred to as internal slot area). Total solution accessible electrode area is calculated as shown in Equation 1:

$$Total Solution Accesible Electrode Area = Wetted Back Face Area + Internal Slot Area \qquad ( Eq . 1 )$$

The amount of DSC, expressed as a ratio of the internal slot area to the solution accessible electrode area is calculated as shown in Equation 2

$$DSC Fraction = \frac{Internal Slot Area}{Total Solution Accesible Electrode Area} \qquad ( Eq . 2 )$$

Electrolytic Ozone Production Gradient: An EOP gradient (mg A cm² L⁻¹) is calculated by applying a least-squares linear fit of the applied current density (in A cm⁻²), y axis, vs. measured ozone concentration (in mg L⁻¹), x axis, for three repeats. Ozone concentration was measured over a constant current range of 0.1 to 0.6 A in 0.1 A increments for all cells. Due to the different electrode geometries investigated, it was necessary to normalize the applied currents with respect to the solution accessible electrode area (see above) for ease of comparison. The steeper the gradient the more efficient the electrode is at producing ozone.

Current Efficiency: Current efficiencies (ε) were calculated using Equation 3:

$$ε = 2 \times \frac{100 \times nFvC}{iM} \qquad ( Eq . 3 )$$

where n is the stoichiometric number of electrons transferred (n=6),⁵F is the Faraday constant in C mol⁻¹, vis the solution flow rate in L s⁻¹, C is the concentration of dissolved ozone in mol L⁻¹, i is the applied current in A, and M is the molecular weight in g mol⁻¹ of ozone. Current efficiencies were calculated for all points on the calibration line. The highest value was chosen as the peak current efficiency, in line with literature precedent.

In previous literature, some EOP cells have been operated in a split product modality, where the anode products (i.e. dissolved ozone) are separated from the cathode products. Product separation allows for optimising parameters such as supporting electrolyte and flow rate for the anode and cathode separately. In contrast, whilst the present perforated electrode cell is capable of delivering cathode/anode products in isolation, all data discussed herein was collected by combining the flow streams for anode and cathode. This setup is more facile and also reflects a mode of operation used commonly in commercially available handheld EOP devices. However, combining flow streams dilutes the maximum ozone output of the perforated electrode cells twofold. Thus, a factor of two was introduced in the current efficiency equation to account for this.

### Effect of Diamond Stabilised Non-Diamond Carbon Incorporation on Perforated Electrodes

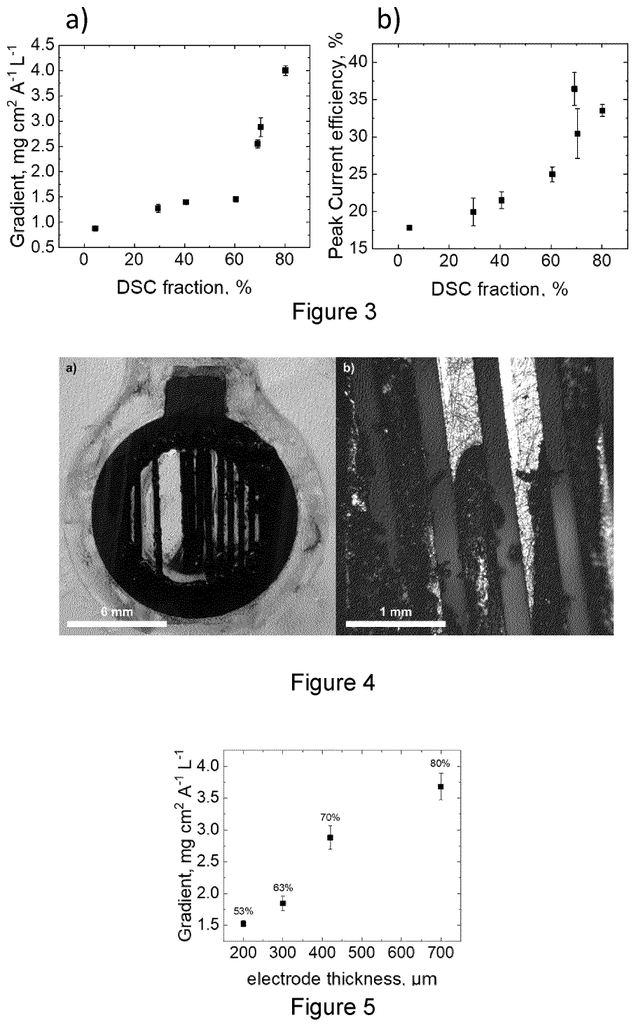

Increasing the DSC content from 0% to 20% has little effect on the ozone output, as shown in FIG. 3a. However, increasing the DSC ratio from 60% to 80% results in a rapid increase in both ozone output gradient (2 to 4.7 mg cm² A⁻¹ L⁻¹). The increase in ozone output gradient with an increase in DSC proportion shows the importance of DSC to ozone generation. There is a similar trend in peak current efficiency, as shown in FIG. 3b, with on average, cells with higher DSC content having a higher peak current efficiency.

While from this data it may seem that an optimal electrode is one which is made from an sp² bonded carbon electrode material (i.e. 100% sp² bonded carbon) such as glassy carbon or graphite, this is not possible due to the fact these sp² bonded carbon electrodes are not DSC or otherwise stable, and will oxidatively corrode under high anodic potentials. For example, the only literature precedent for EOP on 100% sp² bonded carbon electrodes used glassy carbon as the anode. Whilst relatively high current efficiencies of 35% were achieved, it should be noted that the electrodes were operated in an acidic media with a maximum (low) current density of 400 mA cm⁻² in order to prevent oxidative corrosion. This low current density required the use of very large electrodes (20×2.5 cm rods) to generate meaningful concentrations of dissolved ozone. In the present work, when an electrode of identical geometry to the 70% DSC BDD electrode was cut from glassy carbon wafers and used for EOP under our conditions (see above) it was unable to complete a single calibration without sustaining substantial corrosive damage which was obvious to the naked eye, FIG. 4.

By laser ablation followed by post acid oxidative chemical treatment of the BDD, a thin layer of extremely robust DSC is introduced at the solution accessible electrode area, which can survive these high potential applications. The BDD is essentially a conductive vehicle from and on which the DSC is formed. The presence of DSC improves the efficiency of the BDD towards EOP over that offered by low percentage sp² bonded carbon content BDD, in terms of ozone output for a given current density enabling more compact electrodes for the same ozone output.

As both sp² and sp³ bonded carbon electrodes have high overpotentials for the oxygen evolution reaction (OER), the origin of increased ozone output and efficiency is unlikely to be due to decreased competition from the OER. Instead, the observed improvements are thought to be related to the strength with which radicals are absorbed onto the electrode's surfaces, a critical factor in a surface driven process such as ozone generation. BDD electrodes are unique in that hydroxyl radicals are known to be very weakly absorbed on the electrode surface, resulting in them being able to detach from the electrode with relative ease and react with species in solution. It is as a result of this property that BDD electrodes are widely studied for advanced oxidation. Adsorbed hydroxyl radicals are a critical step to the formation of adsorbed oxygen radicals which eventually lead to ozone formation. Hydroxyl radicals will be more strongly absorbed to regions of the electrode which have a high proportion of DSC, resulting in a higher concentration of absorbed radicals, and ultimately producing more ozone.

### Material Thickness and Triple Point Length

Material thickness was also investigated as a method of producing BDD electrodes with a high DSC proportion without changing the electrode geometry. Perforated electrodes with the same design as the 70% DSC electrode in FIG. 3 were cut from BDD samples of thicknesses of 200, 300, 420, and 700 μm, with resulting DSC proportions varying from 53-80%. FIG. 5 shows the ozone gradient versus electrode thickness for a single perforated electrode design. Increasing the thickness from 200 to 700 μm results in an increase in the ozone output gradient. This also provides another example of how changing the fraction (%) of DSC in the design leads to improvements in cell EOP performance.

Another interesting aspect of this work is that it appears to disagree with the ‘Triple Point’ theory as proposed by (Kraft et.al. Electrochemical ozone production using diamond anodes and a solid polymer electrolyte, Electrochem. commun., 2006, 8, 883-886). In this work, the authors state that only regions of the BDD electrode in close proximity to both the Nafion™ membrane and solution are active for the generation of ozone. Since all four of the electrodes in FIG. 5 have an identical slot length (and therefore triple-point length, which is 170 mm for this design) if the triple-point theory was true they should all have the same ozone output gradient which is not the case.

### Long-Term Testing

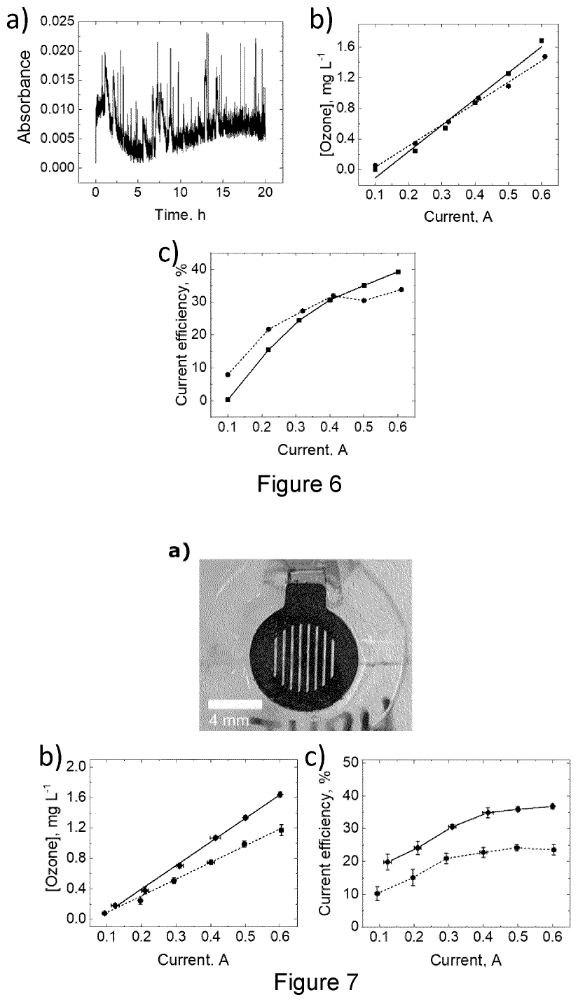

The 70% DSC cell was then subjected to long term stability testing, by running at 0.3 A for 20 hours with the B side as the anode, and continually monitoring the UV absorbance at 258 nm measured. The UV absorbance, as shown in FIG. 6a, and thus dissolved ozone concentration appears relatively constant over the 20 hours, reflecting the long-term operating stability of BDD electrodes. The large amounts of unavoidable spiking in the absorbance data is from bubbles in the flow system, produced during EOP.

Following the long-term stability test, a calibration plot was recorded again (FIG. 6b, red line) and compared to the calibration plot recorded prior to the long-term testing (FIG. 6b, black line) using a flow rate of approximately 300±50 mL min⁻¹; no significant difference was observed. Both calibration plots recorded had good linearity, with R² (adjusted) of 0.9823 and 0.9936 for before and after the 20 hours, respectively.

The maximum dissolved ozone produced, 1.7 mg L⁻¹ (before long term) compared to 1.5 mg L⁻¹ (after long term), for an applied current of 0.6 A, also remained relatively constant, and within the typical errors observed in these cells. In both calibration plots, the amount of ozone generated can be seen to increase linearly as the applied current is increased, with gradients of 3.4±0.2 and 2.7±0.1 mg L⁻¹ A⁻¹ before and after long term testing, respectively (FIG. 6b). Similarly, the current efficiency vs. current plot (FIG. 6c) does not change significantly as a result of the long-term testing, with a maximum efficiency of 39% and 34% before and after long term testing, respectively (FIG. 5c). This data demonstrates the potential for long product lifetimes when utilising BDD electrodes to generate ozone.

### HPHT Electrodes

The efficacy of the HPHT BDD compacts for ozone production was also investigated by comparing an 8 mm HPHT electrode to an 8 mm CVD electrode of identical geometry. The HPHT electrode (shown in FIG. 7a) was 500 μm thick and the corresponding CVD electrode 420 μm thick resulting in DSC proportions of 82 and 79%, respectively.

For both cells, flow rates were 335±4 and 302±6 mL min⁻¹ for the CVD and HPHT cells, respectively. The amount of ozone generated can be seen to increase linearly as the applied current is increased, with gradients of 3.13±0.06 and 2.23±0.07 mg L⁻¹ A⁻¹ for the CVD and HPHT cells, respectively, as shown in FIG. 7b. For the CVD cell, a maximum of 1.64±0.03 mg L⁻¹ dissolved ozone was produced, at the highest applied current of 0.6 A, compared to the HPHT cell where a slightly lower maximum of 1.17±0.07 mg L⁻¹ was produced at 0.6 A. The small difference is most likely due to the lower resistivity of the CVD electrodes (60 mΩ cm), compared to the higher resistivity HPHT electrodes (650 mΩ cm). In the CVD material, the grains inter-grow during synthesis resulting in good electrical connectivity between grains. In contrast, during compaction the grains are forced together. An additional uncompensated resistance is also introduced as a result of solution ingressing into the sub-micron sized pores of the compacted HPHT material.

FIG. 7c compares the current efficiencies between the HPHT and CVD cells. For both cells, the current efficiency increases linearly with applied current from 0.1 to 0.3 A, at which point the gradient decreases and current efficiency begins to plateau. Between 0.4 and 0.6 A, the rate of increase in current efficiency with further applied current is significantly reduced, with a maximum efficiency of 37% and 23% reached for the CVD and HPHT cells, respectively.

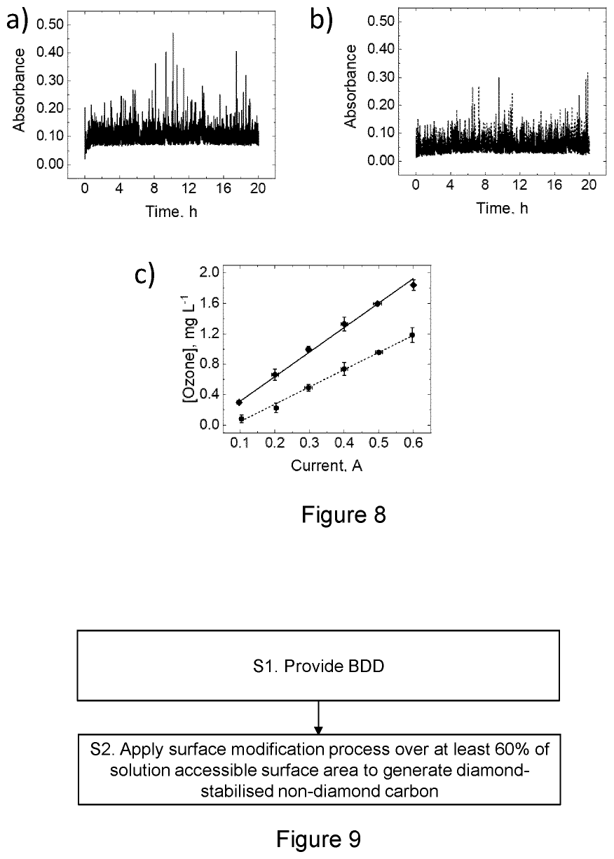

Both cells were then subject to long term stability testing, by running at 0.15 A for 20 h and continually monitoring the UV absorbance at 258 nm (FIGS. 8a and 8b) using flow rates of 194±1 and 193±1 mL min⁻¹ for the CVD and HPHT cells, respectively. Following the long-term stability tests, calibration plots were recorded again (FIG. 8c) and compared to FIG. 6b. For the CVD cell, a slight increase was observed in maximum dissolved ozone produced, 1.84±0.07 mg L⁻¹ compared to 1.64±0.03 mg L⁻¹ for an applied current of 0.6 A. For the HPHT cell, the maximum ozone output of 1.19±0.09 mg L⁻¹ at 0.6 A remained the same, within error. For both cells, the gradients of the fitted calibration data were largely unaffected by the 20 hour run time i.e. for HPHT 2.23±0.07 mg L⁻¹ A⁻¹ (before) versus 2.30±0.08 mg L⁻¹ A⁻¹ (after) and for CVD 3.13±0.06 mg L⁻¹ A⁻¹ (before) versus 3.09±0.08 mg L⁻¹ A⁻¹ (after). Both CVD and HPHT calibration plots recorded after the long-term stability test had excellent linearity, with R² (adjusted) of 0.9882 and 0.9817, respectively. This demonstrates the potential for long product lifetimes, with no decline in performance, when utilising CVD or HPHT BDD electrodes to generate ozone.

Turning now to FIG. 9, there is shown is a flow diagram showing exemplary steps for forming a BDD diamond electrode for EOP. The following numbering corresponds to that of FIG. 9:

S1. Boron doped diamond is provided. As described above, this may be in the form of a CVD diamond, HPHT diamond, or a compact of HPHT diamond.

S2. A surface modification process is applied to the BDD to form a total solution accessible electrode area such that the total solution accessible electrode area comprises at least 60% diamond stabilised non-diamond carbon. As described above, the surface modification process typically includes an ablative process to form sp² bonded carbon and a subsequent treatment to form DSC.

When laser ablation is used as part of the surface modification process, typical laser parameters for BDD are in the following range: wavelength 355 to 1064 nm, pulse lengths 10 to 500 ns at a pulse frequency in the range 50 Hz to 25 MHz, with a fluence of >10 J cm⁻² at a passing speed of 0.1 to 100,000 mm s⁻¹.

When EDM ablation is used, the BDD work piece is placed in a dielectric solution, typically deionised water. A potential applied is between the BDD and a cathode electrode, typically a wire cathode typically brass, 0.1 to 1 mm diameter, at a feed rate of 1 to 15 m min⁻¹, with a typical electrode gap of 0.05 to 0.3 mm and an applied voltage of 5 to 60 V and a current of 0.1 to 5 A, and with a pulse time of 10 to 300 μs. Typical material cut rates vary depending on the resistivity and thickness of the BDD material, but are typically in the range of 0.1 to 10 mm min⁻¹.

Ablative machining has the advantage that freestanding BDD can be post-patterned and with chemical treatment DSC surface coverages of greater than 60% in a cost-effective manner can be easily achieved. Trying to introduce such high coverages via CVD, as taught by Einaga et. al., will significantly compromise the structural integrity and robustness of the resulting material towards EOP. It is also highly unlikely the introduced sp² bonded carbon via CVD growth is DSC; no long term EOP tests are reported in the Einaga et al studies. This is also the reason why ultra-nanocrystalline diamond which due to the growth conditions contains a higher sp² bonded carbon content, often residing at grain boundaries, has not proven suitable for EOP applications.

The ablated area can be a shallow depression, pattern, or other non-planar surface feature, 0.05 to 5 μm in depth, cut into the plane of the electrode. For example, the ablated area may be a vertical wall in the form of a slot cut through the electrode, or a trench in the electrode.

The surface modification process may include applying a chemical treatment process to the ablated region, such as applying an oxidising environment. An example of such an oxidising environment is immersing the electrode in a solution of boiling sulphuric acid and potassium nitrate for a time of at least 10 minutes.

Additional suitable surface modification processes include applying to the solution accessible electrode area an electrochemical anodic process, an oxygen plasma processing, and a chemical/electrochemical reduction process. Where appropriate, these may be performed in-situ in the electrochemical cell in which the electrode is to be used.

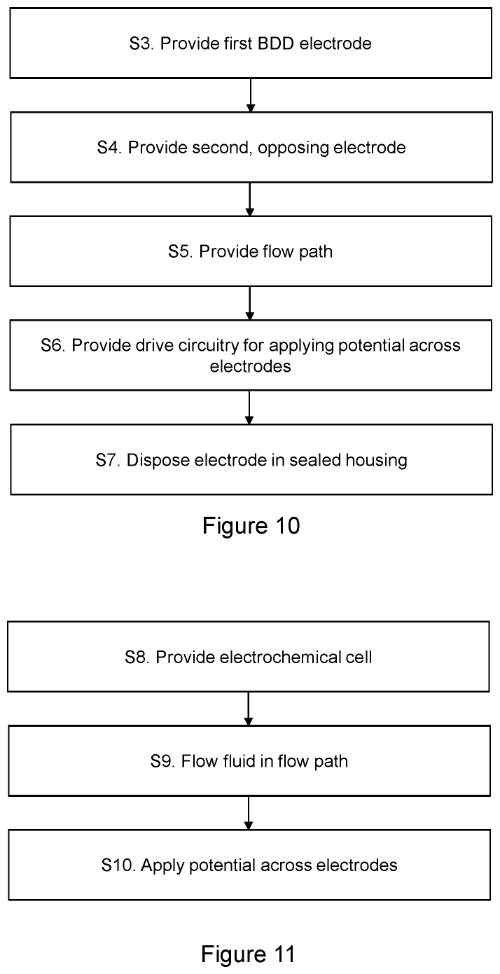

Turning now to FIG. 10, there is shown a flow diagram showing exemplary steps for forming a BDD diamond electrochemical cell. The following numbering corresponds to that of FIG. 10:

S3. A first electrode is provided, consisting of BDD with a total solution accessible electrode area comprising at least 60% diamond stabilised non-diamond carbon as described above. A solid electrolyte such as Nafion™ may be disposed between the first and second electrodes. The solid electrolyte may be hydrating and protonated prior to disposing it between the electrodes, or in-situ in the electrochemical cell.

S4. A second electrode is provided. Typically, this will also comprise BDD with a total solution accessible electrode area comprising at least 60% diamond stabilised non-diamond carbon, but this is not necessary.

S5. A flow path is provided configured for flowing a fluid.

S6. Drive circuitry is provided that is configured to apply an electrical potential across the electrodes such that a current flows between the electrodes when the fluid is flowed through the flow path. Note that the first and second electrodes may be connected to the drive circuitry via a dry electrical contact such that, in use, the only electrochemically active electrode material is the boron doped diamond electrode.

S7. A sealed housing is provided, in which the electrodes are disposed. The sealed housing is configured to, in use, contain the fluid within the flow path.

Turning now to FIG. 11, there is shown a flow diagram showing exemplary steps for using a BDD diamond electrochemical cell.

S8. An electrochemical cell is provided as described above.

S9. Fluid is caused to flow through the flow path.

S10. A potential is applied across the electrodes such that a current flows between the electrodes. Typically, this will cause ozone to be generated from the fluid.

While this invention has been particularly shown and described with reference to preferred embodiments, it will be understood to those skilled in the art that various changes in form and detail may be made without departing from the scope of the invention as defined by the appendant claims. For example, while the examples above used high % DSC-BDD electrodes for both electrodes either side of a Nafion™ membrane, it will be appreciated that only one electrode need be a high % DSC-BDD electrode.

1. An electrode formed from boron doped diamond, and the electrode having a total solution accessible electrode area comprising at least 60% diamond stabilised non-diamond sp2 carbon.

2. The electrode according to claim 1, wherein the total solution accessible electrode area comprises at least 70% diamond stabilised non-diamond sp2 carbon.

3. The electrode according to claim 1, wherein the diamond stabilised non-diamond sp2 carbon comprises oriented graphite bonded to the diamond surface with a layer of amorphous carbon, wherein the graphite is oriented at the point of bonding to the diamond surface at greater than 20° relative to the plane of the total solution accessible electrode area.

4.-5. (canceled)

6. The electrode according to claim 1, wherein the boron doped diamond is in the form of a coated layer on a conductive or non-conductive backing.

7.-9. (canceled)

10. The electrode according to claim 1, wherein the solution accessible electrode area further comprises any of slots, depressions and non-planar surface features.

11. (canceled)

12. An electrochemical cell comprising:
a first electrode, the first electrode being the electrode of claim 1;
a second opposing electrode;
a flow path configured for flowing a fluid;
drive circuitry configured to apply a potential across the electrodes such that a current flows between the electrodes when the fluid is flowed through the flow path; and
a sealed housing in which the electrodes are disposed, the housing configured to contain the fluid within the flow path.

13. The electrochemical cell according to claim 12, wherein the electrochemical cell is configured for ozone generation when in use.

14. The electrochemical cell according to claim 12, wherein, during use and over a voltage range of 5 to 10 V and a current density range of 0.01 up to 0.05 A cm⁻² with de-ionized (greater than 15 MΩ cm) water at a nominal temperature of 25° C. and a flow rate of 240 ml⁻¹, the peak ozone current efficiency is greater than 25%.

15. The electrochemical cell according to claim 14, wherein the peak ozone current efficiency is at least 30%.

16-18. (canceled)

19. A method of forming an electrode, the method comprising:
providing boron doped diamond,
applying a surface modification process to form a total solution accessible electrode area comprising at least 60% diamond stabilised non-diamond sp2 carbon.

20. The method according to claim 19, wherein the surface modification process comprises an ablative machining process.

21.-24. (canceled)

25. The method according to claim 20, wherein the ablative machining process is further used to form any of slots, depressions and non-planar surface features at the solution accessible electrode area.

26. The method according to claim 19, further comprising applying an oxidising process step to the total solution accessible electrode area, the oxidising process comprising applying an oxidising environment to the solution accessible electrode area.

27. The method according to claim 26, wherein the oxidising process comprises treating for at least 10 minutes in a liquid comprising any of:
sulphuric acid and potassium nitrate;
sulphuric acid and hydrogen peroxide;
nitric acid and hydrochloric acid;
hydrofluoric acid;
hypochlorous acid;
nitric acid, perchloric acid and sulphuric acid; and
permanganates selected from any of potassium permanganate, ammonium permanganate, calcium permanganate, sodium permanganate, and silver permanganate.

28. The method according to claim 26, wherein the oxidising process comprises electrochemical oxidation.

29.-33. (canceled)

34. A method of using an electrochemical cell, the method comprising:
providing an electrochemical cell as claimed in claim 12;
causing a fluid to flow in the flow path; and
applying a potential across the electrodes such that a current flows between the electrodes.

35. (canceled)

36. The electrode according to claim 1, wherein the total solution accessible electrode area comprises at least 80% diamond stabilised non-diamond sp2 carbon.

37. The electrode according to claim 1, wherein the total solution accessible electrode area comprises at least 90% diamond stabilised non-diamond sp2 carbon.

38. The electrode according to claim 1, wherein the total solution accessible electrode area comprises at least 95% diamond stabilised non-diamond sp2 carbon.

39. The electrochemical cell according to claim 14, wherein the peak ozone current efficiency is at least 35%.
